(19) United States
(12) Patent Application Publication
(10) Pub. No.: US 2009/0101366 A1
(43) Pub. Date: Apr. 23, 2009

(54) Homeland fire suppression system

(76) Inventors: Joseph Denardo, Pagosa Springs, CO (US); Ann Ellerman-Denardo, Pagosa Springs, CO (US)

Correspondence Address: JAMES RAY & ASSOCIATES, 2640 PITCAIRN ROAD, MONROEVILLE, PA, 15146, US

(21) Appl. No.: 12/288,251

(22) Filed: Oct. 17, 2008

Related U.S. Application Data
(60) Provisional application No. 60/999,335, filed on Oct. 17, 2007.

(51) Int. Cl. A62C 35/00

(52) U.S. Cl. 169/14

(57) ABSTRACT

A fire suppression system for effectively subduing fires. The fire suppression system comprises an underground water tank having a first predetermined size specifically calculated to meet the needs of such property to be protected. A pre-charged foam proportioning device containing dry foam powder is engageable with the underground water tank. The system includes a system engageable with such underground water tank and with such foam proportioning device for dispensing a water/foam mixture for such property to be protected.

### CROSS REFERENCE TO RELATED APPLICATIONS

This application is closely related to and claims benefit from U.S. Provisional Application Ser. No. 60/999,335 filed Oct. 17, 2007.

### FIELD OF THE INVENTION

The present invention relates, in general, to a fire suppression system, and, more particularly, the present invention relates to a system for blanketing a home and surrounding property with a foam/water mixture by a touch of a button.

### BACKGROUND OF THE INVENTION

Wildfires are becoming more common every year. While the incidents of wildfires increase, the technology on how to fight them has not. Helicopters and hoses do little to extinguish the fires, which can continue their paths of destruction for days and even weeks. Current models of fire suppressant systems, both in the private and public sector, are portable units that have to be operated by a person and physically relocated to the site of the fire. This leaves the operator completely unprotected as they fight the fire. Each year countless lives are lost and tens of millions of dollars in damage are incurred due to the problem of wildfires that has gone nearly unchecked. There has been a void in the market for a low cost easily installed system that could solve the dilemma of wildland/urban interface fire protection.

It is and has been frightening to watch on television a raging wildfire encompass a property and see the owner helpless watching his prized possession being destroyed.

Thus, it would be advantageous if there were a simple low cost means of effectively subduing a fire and preventing it from spreading and destroying more wildlife, human life and property. The value of such a system is such that it could become a mandatory installation because of its ability to instantaneously and effectively subdue fire.

### SUMMARY OF THE INVENTION

In a first aspect the present invention provides a fire suppression system for effectively subduing fires. The fire suppression system comprises an underground water tank having a first predetermined size specifically calculated to meet needs of property to be protected. There is a pre-charged foam proportioning device containing dry foam powder that is engageable with the underground water tank. A means is engageable with the underground water tank and with the foam proportioning device for dispensing a water/foam mixture for such property to be protected.

### OBJECTS OF THE INVENTION

It is, therefore, one of the primary objects of the present invention to provide an apparatus to prevent fire from entering a users property.

Another object of the present invention is to provide an apparatus that would suppress a fire by smothering the fire and starving it for oxygen.

Still another object of the present invention is to provide an apparatus that utilizes an underground water tank.

Yet another object of the present invention is to provide an apparatus that includes a foam/water mixture to suppress the fire.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a side perspective view of a part of the apparatus for a fire suppression system showing the generator, foam proportioning device and the underground water tank.

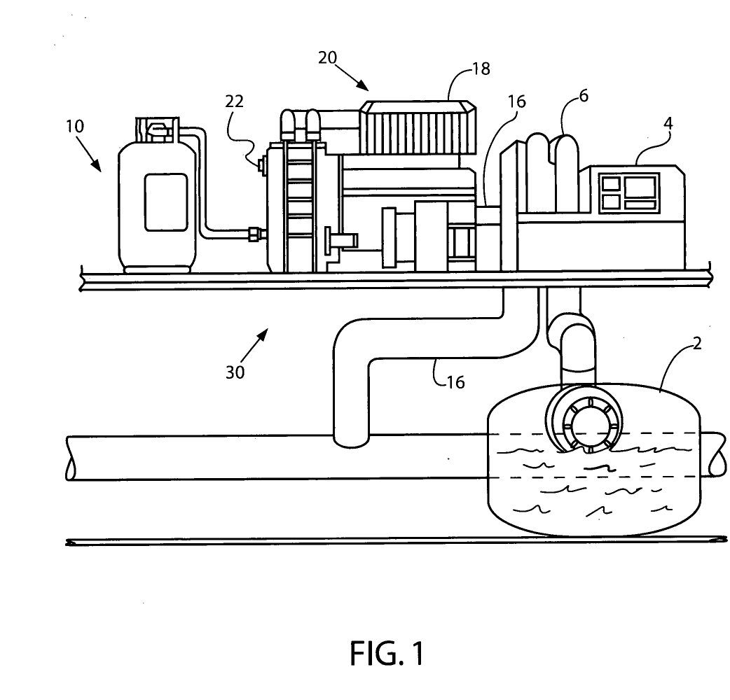

FIG. 2 is a partial bottom perspective view of the apparatus for the fire suppression system according to an embodiment of the invention showing the connecting lines and the position of the foam cannons.

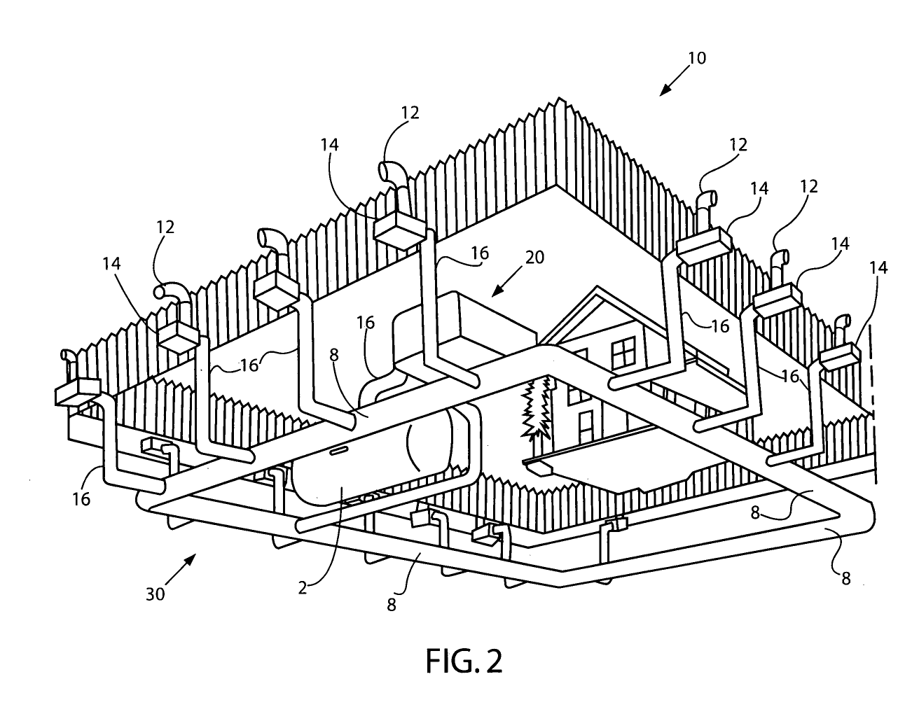

FIG. 3 is an enlarged side perspective view of the high expansion foam cannons of the present invention.

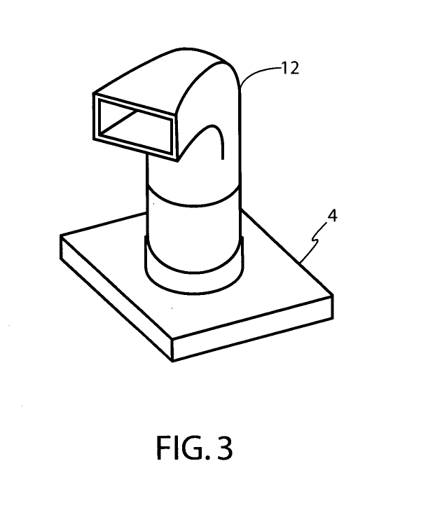

FIG. 4 is a partial bottom perspective view of the apparatus for the fire suppression system according to an embodiment of the invention showing the foam cannons pointed in toward the property and showing foam cannons on a rooftop of a building.

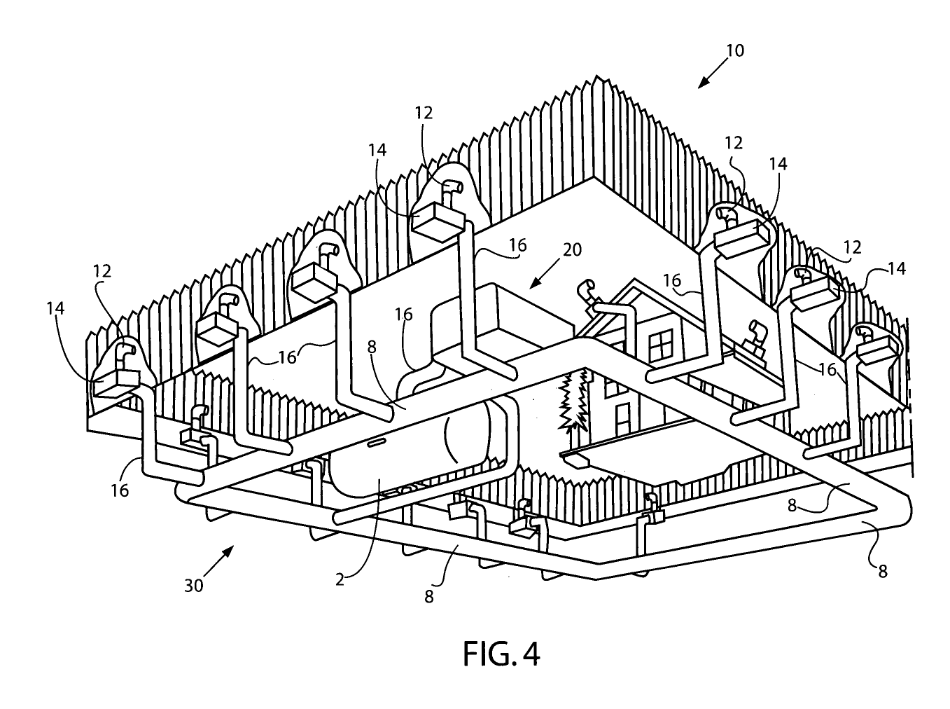

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides a fire suppression system, generally designated 10, for effectively subduing fires. The fire suppression system 10 comprises an underground water tank 2 having a first predetermined size specifically calculated to meet needs of property to be protected. There is a pre-charged foam proportioning device 4 containing dry foam powder that is engageable with the underground water tank 2. A means, generally designated 30, is engageable with the underground water tank and with the foam proportioning device for dispensing a water/foam mixture for such property to be protected.

The means 30 includes a pump member 6 having a predetermined flow capability which is at least sufficient to protect such property being protected. Such means 30 further includes irrigation lines 8 that are disposed around a perimeter of such protected property, such irrigation lines 8 for receiving output from the pump 6.

The means 30 further includes a plurality of high expansion foam cannons 12 that are engageable with the irrigation lines 8 for spraying a foam/water mixture in event of a fire, such plurality of foam cannons 12 are disposed on such perimeter of such property. The means 30 also includes a water driven fan 14 that is engageable with the plurality of high expansion cannons 12 for super mixing the water/foam mixture as it is received from the irrigation lines 8. Such means 30 further includes a plurality of connecting lines 16 for transporting water from the underground water tank 2 to such foam proportioning device 4 and the water/foam mixture from the proportioning device 4 to the irrigation lines 8 and such pump member 6 and from the irrigation lines 8 to such plurality of high expansion foam cannons 12.

The fire suppression system 10 further includes a means 20 disposed closely adjacent the foam proportioning device 4 for providing power to the fire suppression system 10. It is presently preferred that such means for providing power 20 includes a generator 18 and it is even more preferred that such generator 18 is a propane generator 18.

The fire suppression system further includes a switch member 22 for turning on the fire suppression system 10. Such switch member 22 is disposed on the generator 18. It is presently preferred that such switch member 22 is a push button switch 22.

The fire suppression system 10 is effective for subduing wildland fires within a wildland/urban interface. This is accomplished by spraying the foam/water mixture around the periphery of the property so as to prevent any wild fire from coming onto the property.

Such fire suppression system 10 further includes at least two foam cannons 12 disposed on a rooftop of buildings on such property to prevent relighting due to ambient embers and also includes connecting lines 16 for transporting water/foam mixture from the foam proportioning device 4 and from the irrigation lines 8 to such additional foam cannons 12 disposed on such rooftop of such building(S) on the property.

It should be noted that the high-expansion cannons 12 are spray heads incorporated into the irrigation lines 8 around such property. It is also preferred that such fire suppression system 10 further includes a plurality of foam cannons 12 disposed around a perimeter of such property with the foam cannons 12 pointing inwardly so as to spray such water/foam mixture inside such property in case the fire is on such property.

It is within the scope of the invention that such system could also be energized or activated by having remotely disposed heat sensors around the perimeter of such property which could turn on the system. The system would be activated whenever the sensors sensed a predetermined temperature. This remote sensing feature would be important if the property owners were not at the residence, such as being on vacation. Thus, in the event of a wildfire when the property owners are not at home the system would be automatically turned on when such predetermined heat was sensed and, thus, save the property.

Thus, the present invention provides a wildland fire suppression system that is a completely stand-alone, off-grid system that effectively and instantaneously subdues wildland fire within the wildland/urban interface. The user would simply press a button from inside the property, or the system could remotely activate by means of heat sensors that would be strategically located around the perimeter of the property. The system would activate, discharging completely biodegradable, environmentally friendly Class A foam, to retard the fire and prevent it from entering the property. If the fire were already on the property the fire suppression system would smother the fire with high-expansion foam, starving it of oxygen and extinguishing the fire. The fire suppression system's main component is an underground water tank with a size specifically calculated to meet the needs of the property. Connected to the tank is a precharged Class A foam-proportioning device. The dry foam powder, when hydrated, is a thousand times more effective than water alone for extinguishing fire. In line from the proportioning device is the pump, which is also governed to the specific size of the property. The pump delivers maximum pounds per square inch to the irrigation lines, located around the perimeter of the protected property. Connected to the irrigation lines around the property, are a series of unique, high-expansion foam cannons that exponentially add to its life and property-saving abilities, more so than any other system. These high-expansion cannons are actually the spray heads incorporated into the irrigation lines around the property. The high-expansion cannons have a water driven fan so that when the water/foam mixture comes in from the irrigation lines, it super-mixes the water/foam at a very high pressure, thus, creating approximately a 2inch depth of oxygen-starving foam, per square inch of land, onto the property. The whole system is powered by a stand alone, high output propane generator. Thus, a person can effectively protect their home, property, life and family from the destructive effects of wild fires whether they home or away from home. Additional nozzles could also be installed on the rooftops to prevent relighting due to ambient embers.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

We claim:

1. A fire suppression system for effectively subduing fires, said fire suppression system comprising:
(a) an underground water tank having a first predetermined size specifically calculated to meet needs of property to be protected;
(b) a pre-charged foam proportioning device containing dry foam powder and engageable with said underground water tank;
(c) a means engageable with said underground water tank and with said foam proportioning device for dispensing a water/foam mixture for such property to be protected.

2. The fire suppression system, according to claim 1, wherein said means includes a pump member having a predetermined flow capability which is at least sufficient to protect such property being protected.

3. The fire suppression system, according to claim 2, wherein said means further includes irrigation lines disposed around a perimeter of such protected property, said irrigation lines for receiving output from said pump.

4. The fire suppression system, according to claim 3, wherein said means includes a plurality of high expansion foam cannons engageable with said irrigation lines for spraying a foam/water mixture in event of a fire, said plurality of foam cannons disposed on such perimeter of such property.

5. The fire suppression system, according to claim 4, wherein said means includes a water driven fan engageable with said plurality of high expansion cannons for super mixing said water/foam mixture as it is received from said irrigation lines;

6. The fire suppression system, according to claim 5, wherein said means includes a plurality of connecting lines for transporting water from said underground water tank to said foam proportioning device and said water/foam mixture from said proportioning device to said irrigation lines, said pump member and from said irrigation lines to said plurality of high expansion foam cannons.

7. The fire suppression system, according to claim 1, wherein said system further includes a means disposed closely adjacent said foam proportioning device for providing power to said fire suppression system.

8. The fire suppression system, according to claim 7, wherein said means for providing power includes a generator.

9. The fire suppression system, according to claim 8, wherein said generator is a propane generator.

10. The fire suppression system, according to claim 8, wherein said fire suppression system further includes a switch member for turning on said fire suppression system.

11. The fire suppression system, according to claim 10, wherein said switch member is disposed on said generator.

12. The fire suppression system, according to claim 11, wherein said switch is a push button switch.

13. The fire suppression system, according to claim 1, wherein said fire suppression system is effective for subduing wildland fires within a wildland/urban interface.

14. The fire suppression system, according to claim 1, wherein said fire suppression system further includes at least two foam cannons disposed on a rooftop of buildings on such property to prevent relighting due to ambient embers.

15. The fire suppression system, according to claim 5, wherein said fire suppression system further includes connecting lines for transporting water from said foam proportioning device and from said irrigation lines to said additional foam cannons disposed on such rooftop of such building on said property.

16. The fire suppression system, according to claim 4, wherein said high-expansion cannons are spray heads incorporated into said irrigation lines around such property.

17. The fire suppression system, according to claim 1, wherein said fire suppression system further includes a plurality of foam cannons disposed around a perimeter of such property with said foam cannons pointing inwardly so as to spray such water/foam mixture inside such property in case a fire is on such property.
